(19) United States
(12) Patent Application Publication
(10) Pub. No.: US 2012/0064501 A1
(43) Pub. Date: Mar. 15, 2012

(54) Systems and Methods for Evaluation of Automatic Content Scoring Technologies

(76) Inventor: Jana Z. Sukkarieh, Princeton, NJ (US)

(21) Appl. No.: 13/082,519

(22) Filed: Apr. 8, 2011

Related U.S. Application Data
(60) Provisional application No. 61/322,001, filed on Apr. 8, 2010.

(51) Int. Cl. G09B 7/00

(52) U.S. Cl. 434/353

(57) ABSTRACT

Systems and methods are provided for evaluating an automatic content scoring technology. A first text and a second text are received. A determination by the first automatic content scoring technology on whether at least a portion of the first text entails the second text, does not entail the second text, or refutes the second text is received. A determination by a human rater on whether at least a portion of the first text, entails the second text, does not entail the second text, or refutes the second text, and a reason for the determination by the human rater are received. The determination by the first automatic content scoring technology and the determination by the human rater are compared. A report is output indicating quality of the determination by the first automatic content scoring technology and showing disagreement between the determination by the first automatic content scoring technology and the determination by the human rater.

### CROSS-REFERENCE TO RELATED APPLICATIONS

This application claims priority to U.S. Provisional Patent Application No. 61/322,001 filed Apr. 8, 2010, entitled “Building a Textual Entailment Suite for the Evaluation of Automatic Content Scoring Technologies,” the entirety of which is herein incorporated by reference.

### FIELD

The technology described herein relates generally to automatic content scoring and more particularly to evaluation of automatic content scoring technologies.

### BACKGROUND

The education community is continually moving towards constructed or free-text responses. The community is also moving towards widespread computer-based assessments. At the same time, progress in natural language processing (NLP) and knowledge representation (KR) has made it possible to consider free-text responses without having to fully understand the text. Automatic content scoring for free-text responses has started to emerge as an application of Natural Language Processing (NLP) in its own right, much like question answering or machine translation.

### SUMMARY

Systems and methods are provided for evaluating an automatic content scoring technology. A first text and a second text are received. A determination by the first automatic content scoring technology on whether at least a portion of the first text entails the second text, does not entail the second text, or refutes the second text is received. A determination by a human rater on whether at least a portion of the first text entails the second text, does not entail the second text, or refutes the second text, and a reason for the determination by the human rater are received. The determination by the first automatic content scoring technology and the determination by the human rater are compared. A first report is output indicating quality of the determination by the first automatic content scoring technology and showing disagreement between the determination by the first automatic content scoring technology and the determination by the human rater based on the reason.

### BRIEF DESCRIPTION OF THE DRAWINGS

FIG. 1 depicts an example of a test item with required concepts for a student response.

FIG. 2 depicts an example diagram showing main steps of automatic content scoring (ACS) being carried out as a textual entailment task.

FIG. 3 depicts an example block diagram of an ACS evaluation system used for evaluating performance of an ACS technology or different ACS technologies.

FIG. 4 depicts an example flow diagram of benchmarking performance evaluation for an ACS technology.

FIG. 5 shows example results of disagreement/agreement between an ACS technology and a human rater in terms of confusion matrices over some categories of example engine tests.

FIG. 6 shows example results of disagreement/agreement between the ACS technology and the human rater for other categories of the example engine tests.

FIG. 7 depicts an example flow diagram for evaluating performance of two different ACS technologies.

FIG. 8 shows an example comparative results when two ACS technologies apply to a set of engine tests.

FIG. 9 depicts an example screen shot of an ACS evaluation system.

FIG. 10 depicts another example screen shot of an ACS evaluation system.

FIG. 11 depicts a computer-implemented environment wherein users can interact with an ACS evaluation system hosted on one or more servers through a network.

FIG. 12 depicts a stand-alone computer hosting an ACS evaluation system for access by a user.

### DETAILED DESCRIPTION

An automatic content scoring (ACS) technology, such as c-rater® of Educational Testing Service (ETS), can perform automatic content scoring of free-text responses. For example, a test item may require a set of main/key points or concepts. The ACS technology may aim to score student responses to the test item for evidence of what a student knows vis-a-vis these concepts.

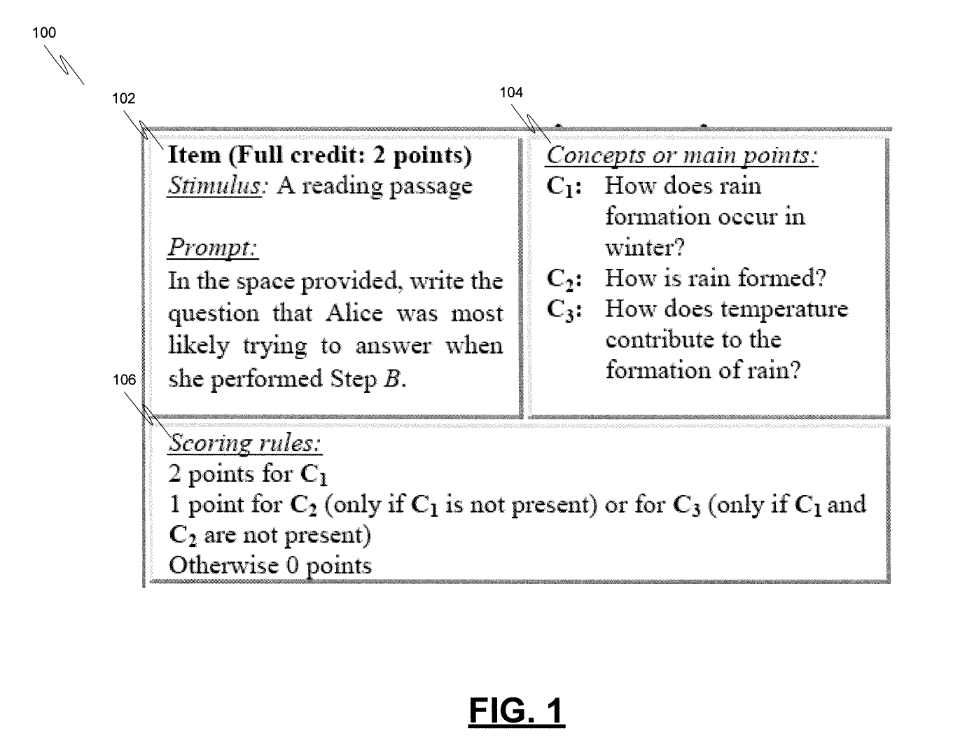

FIG. 1 depicts at 100 an example of a test item 102 with required concepts 104 for a student response. The test item 102 includes a stimulus and a prompt, and requires a set of concepts or main points 104 including C1, C2 and C3. Scoring rules 106 dictate how score points are assigned to a student response to the test item 102. ACS of a student response to the test item 102 may be carried out as a textual entailment task, e.g., determining whether the student response or part of the student response entails the given concept(s). For example, the test item 102 requires a concept, (e.g., C3 in Table 1 “How does temperature contribute to the formation of rain?”). Given a student response, A, (e.g., either “How does temperature assist in the formation of rain?” or “Does temperature affect the way altitude helps in rain formation?”) and the context of the test item 102, the goal of ACS of the student response A is to check whether the concept is an inference or paraphrase of A.

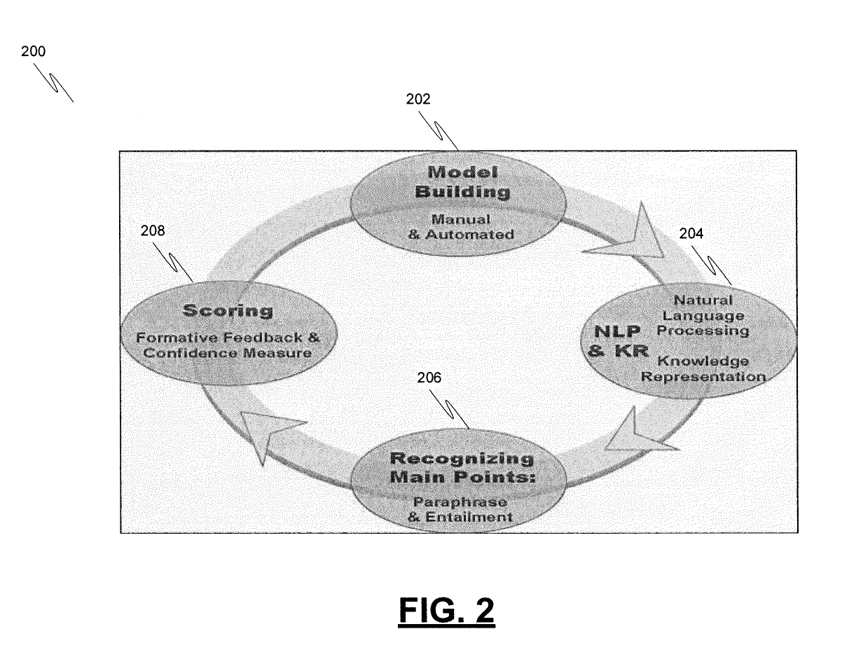

FIG. 2 depicts at 200 an example diagram showing main steps of ACS being carried out as a textual entailment task. The process includes item-dependent Model Building at 202. A set of model responses are generated for a test item guided by a set of scored student responses and a set of lexical resources generating similar lexicon. In a scored student response, a human rater highlights what he considers to be a portion of the student response that entails a concept and labels a <Response, Concept> pair with an analytic-based score “Present,” or the human rater highlights a portion of the student response that refutes the concept and labels the <Response, Concept> pair with an analytic-based score “Refuted.” Otherwise the human rater considers that the student response does not entail the concept and labels the pair <Response, Concept> with an analytic-based score “Absent.” The highlighted portion corresponding to an entailment is a positive evidence and the highlighted portion corresponding to a refutation is a negative evidence.

The process also includes Natural Language Processing (NLP) and Knowledge Representation (KR) at 204. Model answers and student responses are automatically processed using a set of Natural Language Processing tools, and resources. In the process, a set of linguistic features are extracted, including the following stages. A student response is processed for spelling corrections in an attempt to decrease the noise for subsequent NLP tools. Tokenization, parts-of-speech tagging and parsing are performed. Thereafter, a parse tree is passed through a feature extractor where features are extracted from the parse tree and semantic roles are introduced based on manually-generated rules. A pronoun resolution stage is performed where pronouns are resolved to either an entity in the student response or the test item. A morphology analyzer reduces the words to their lemmas.

At 206, recognizing main points is performed. A concept-detector uses the linguistic features culminated from both Model Building (MB) and Natural Language Processing (NLP) to automatically determine whether a student response entails predefined concepts. The fourth step is scoring at 208. Based on scoring rules, a total score and feedback justifying the total score are produced.

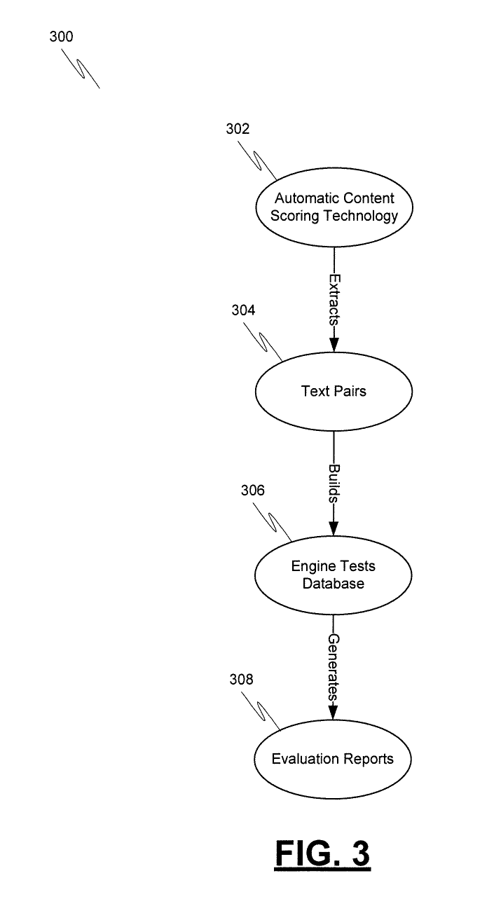

FIG. 3 depicts at 300 an example block diagram of an ACS evaluation system used for evaluating performance of an ACS technology 302. For example, the ACS evaluation system may be built based on naturally-occurring real student responses collected from various assessment programs and varying content areas that the ACS technology 302, such as c-rater®, has processed, model student responses, or texts from external sources (e.g., internet sources or test item rubrics, etc.). Text pairs 304 may be extracted from a database of the ACS technology 302, or extracted by the ACS technology 302 from the external sources. For example, a pair of texts may include a student response and a concept that are associated with a test item, a student response and a model response, a student response and a text that is not associated with a test item, or two texts that are not associated with a test item. Based on the text pairs 304, a database of engine tests (or tuples) 306 may be built, e.g., automatically or partially automatically.

The database of engine tests may be built from “typical” or representative well written English data. Or, the database of engine tests may be built from naturally-occurring “atypical” data in real world student responses. “Atypical data” may include noise, unconventional textual representation and mixed-mode representation. Noise may include incomplete sentences, misspellings, ungrammaticality and random keyboard indefinite stroking of the same letter. Noise varies from one grade level to another, from one population to another and from one content area to another. Unconventional textual representation may include symbols, short message service (SMS) abbreviations, foreign and slang words. Furthermore, some content areas require students' responses in mixed-mode: visual, textual and mathematical symbolic language.

For example, an engine test may include a text pair, such as a student response and a concept. Further, the engine test may include an ACS label indicating the ACS technology's determination on whether one text in the text pair or part of the text entails the other text in the text pair, does not entail the other text, or refutes the other text. Also, a human label may be included in the engine test to indicate that a human rater's determination on whether one text in the text pair or part of the text entails the other text in the text pair, does not entail the other text, or refutes the other text. The principle of building a database of engine tests is to build a set of engine tests that may ensure that the decision of a concept-detector be consistent. That is, the agreements/disagreements between the human labels and the ACS labels of the set of engine tests may be consistent from one version of the ACS technology to another version, or from one ACS technology to another ACS technology.

Based on the engine test database 306, the ACS evaluation system may be used to benchmark performance evaluation for the ACS technology 302. For example, the ACS evaluation system may be used to determine how many engine tests the ACS technology 302 produces a correct decision for. This is evaluated in terms of agreement with a human rater. Additionally, the ACS evaluation system may be used to evaluate performance of different ACS technologies, including different versions of an ACS technology. Evaluation reports 308 may be generated, e.g., indicating certain qualities of the ACS technology.

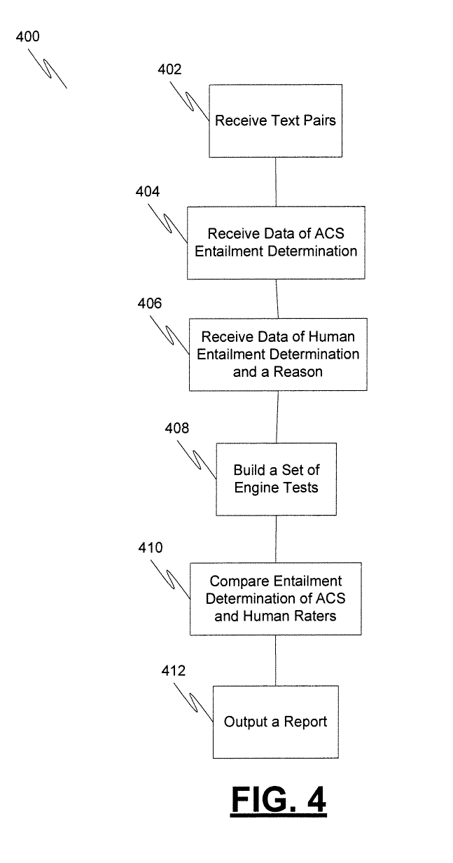

FIG. 4 depicts at 400 an example flow diagram of benchmarking performance evaluation for an ACS technology. Text pairs may be received at 402, e.g., from a database of an ACS technology or external sources. For example, a pair of texts may include a student response and a concept that are associated with a test item, a student response and a model response, a student response and a text that is not associated with a test item, or two texts that are not associated with a test item.

Data of the ACS technology's entailment determination are received at 404, including data related to the ACS technology's determination on whether one text in each text pair or part of the text entails the other text in the text pair, does not entail the other text, or refutes the other text. Data of human entailment determination are received at 406, including data related to one or more human raters' determination, based on a reason (or category), on whether one text in each text pair or part of the text entails the other text in the text pair, does not entail the other text, or refutes the other text. For example, two human raters may be asked to make human entailment determination without consulting each other, and a third human rater may adjudicate when the two human raters disagree. When the three human raters cannot decide on a given pair, the given pair is discarded and replaced with another pair.

A reason (or category) can be any of the following, a linguistic phenomenon, an unexpected output of an NLP module of the ACS technology, mixed-mode representation, and unconventional textual representation. One or more linguistic phenomena may exist in a text, i.e., each linguistic phenomenon constitutes a criterion that determines whether the text entails another text, does not entail or refutes it. For example, an ergative verb is the criterion for which “you could heat bricks” could entail the concept “your bricks could heat.” A linguistic phenomenon could be general. For example, “implicit negation” is the criterion for which “clouds prevented him from seeing the moon” refutes “he can see the moon.” More than one phenomena could be at play when deciding about an entailment. An unexpected output of an NLP module of the ACS technology (e.g., a spelling corrector, a concept-detector, etc.) may mean that a text is well-written but the NLP module's output is unexpected, or that the text is noisy and hence the NLP module produces wrong output that affects the decision of a concept-detector of the ACS technology.

A set of engine tests may be built at 408, based on the received text pairs, the received data of ACS entailment determination, and the received data of human entailment determination. For example, an engine test may be in the form of <Test_id, Text, Hypothesis, Human_Label, ACS_Label, Category>. Test_Id may be a unique id given to the engine test. Text may be a naturally-occurring student response or part of a student response associated with a test item, or a text not associated with a test item. Hypothesis may be a concept given by the rubric of a test item or a positive evidence for the concept, or a text not associated with a test item. For example, Text and Hypothesis are extracted from the ACS technology's database or external sources. Human_Label is an analytic-based score given by a human rater, i.e. Present, Refuted, or Absent. ACS_Label is an analytic-based score given by the ACS technology. Initially, ACS_Label for each engine test is “Absent” which gets replaced by an analytic score that the ACS technology assigns automatically.

As an example, an engine test may be built by selecting a category (e.g., a linguistic phenomenon), a hypothesis (e.g., a concept), and a text (e.g., a naturally-occurring student response or part of the response) entailing the hypothesis due to the category. Additionally, one or more engine tests may be generated where the text may be injected manually with some variations where the injected text (variations of text) does not entail hypothesis. As another example, an engine test may be built with fewer fields, such as <Test_Id, Text, Hypothesis, Human_Label, ACS_Label>. As another example, an engine test or a set of engine tests may be built in absence of data for one field, e.g., ACS_Label, Human_Label, etc.

Many categories may be included in the set of engine tests, such as syntactic categories, lexical categories, semantics beyond lexicon categories. The syntactic categories may include phenomena like Passives, Ergative, Partitives, Possessives, Comparatives and Superlatives, Phrasal Verbs, Appositives, Dependent Clauses other than appositives, Interrogatives, Extraposition, Adverb final and non-final, Nominalization to Tensed Clause, Finite to Non-finite Constructions, and None of the syntactic categories above. The lexical categories may include phenomena like Exact Lexical Overlap, Direct Synonymy Replacement (not including compound synonymy), Compound Synonymy, Lexical Inference, and Compounds_Other.

Additionally, a category of “tool/module X” may be included, meaning unexpected output of tool X. X can be, e.g., a pre-parser, a parser, a pronoun-resolver, a feature-extractor, or a concept-detector. Engine tests with Human_Label of “Refuted” may be categorized into at least three categories: Explicit Negation, Implicit Negation, and Contradictory Information (other than negation). Engine tests with labels of “Absent” are not categorized. One engine test may belong to more than one category. The selection of a certain category is often guided by the rubrics of a certain test item.

Comparison of the Human_Labels and the ACS_Labels of the set of engine tests may be performed at 410, and the agreements/disagreements between the Human_Labels and the ACS_Labels of the set of engine tests may be recorded. A report may be generated for evaluating quality of the ACS entailment determination. Some statistics like: quadratic kappa statistics, confusion matrices, and precision and recall may be included in the report. Parameters of the ACS technology may be adjusted to improve performance of the ACS technology, such as taking into account some linguistic phenomena the ACS technology did not cover previously, and improving NLP modules' ability to deal with noisy responses.

As an example, results on 456 engine tests are summarized as follows. Table 1 shows some example statistics of these example engine tests.

TABLE 1

| | Hypothesis | Text |
|---|---|---|
| Avg. # Sentences per test | 1.00 | 1.49 |
| Avg. #Tokens per test | 7.65 | 26.86 |
| Avg. #Tokens per test w/out | 6.64 | 25.38 |
| end punctuation | | |

Table 2 depicts an example confusion matrix of the agreement/disagreement between a human rater and an ACS technology.

TABLE 2

ACS Technology

| | | Absent | Present |
|---|---|---|---|
| Human | Absent | N1 | N2 |
| | Present | N3 | N4 |

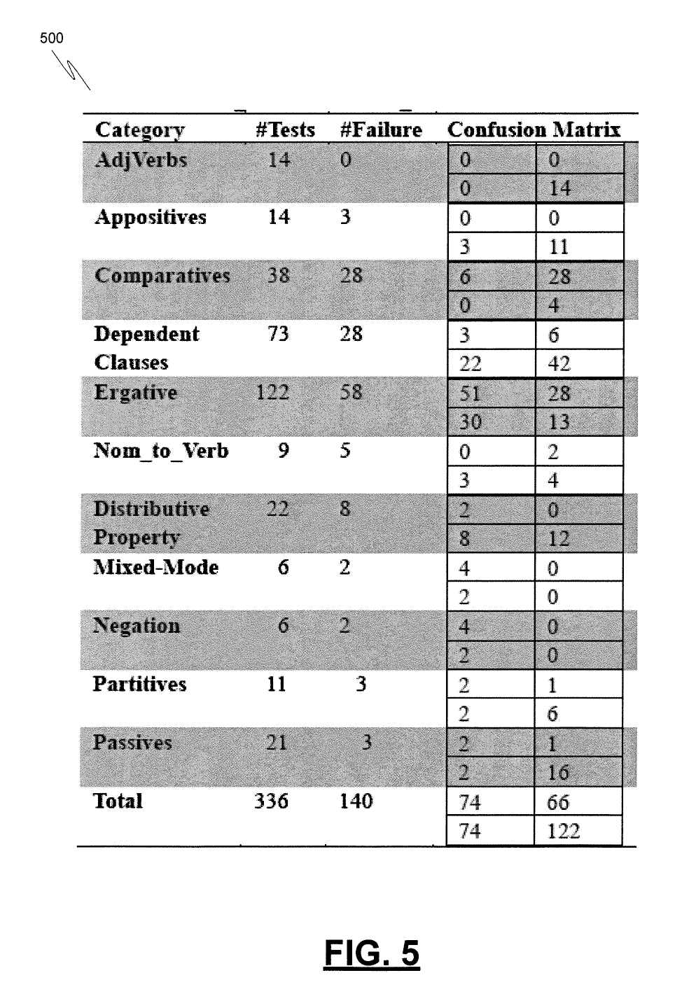

FIG. 5 shows at 500 example results of disagreement/agreement between an ACS technology and a human rater in terms of confusion matrices over some categories of the example engine tests. For example, there are 140 engine tests labeled “Absent” by the human rater and 196 labeled “Present.” The ACS technology fails to agree with the human rater on 140 engine tests.

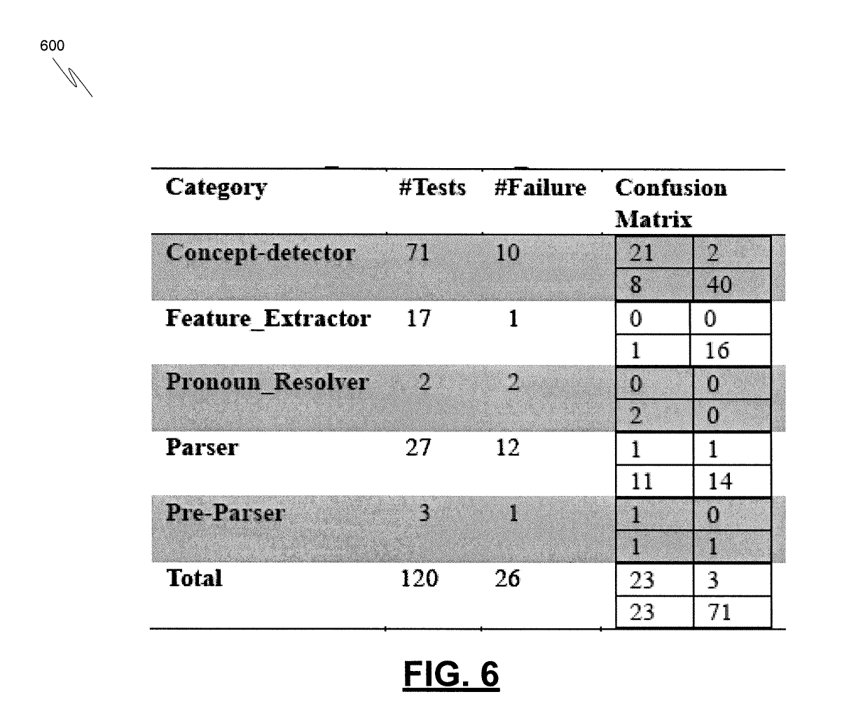

FIG. 6 shows at 600 example results of disagreement/agreement between the ACS technology and the human rater for other categories of the example engine tests. For example, the ACS technology fails to agree with the human rater on 26 engine tests.

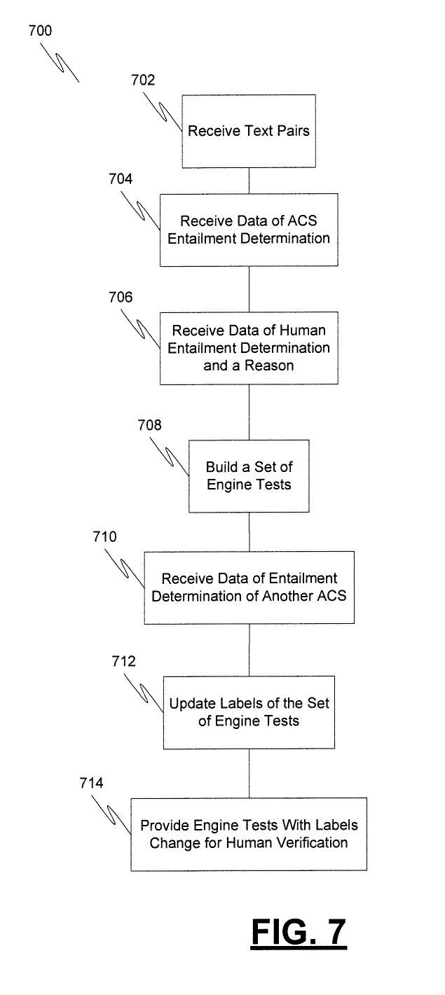

Not only can the ACS evaluation system be used to benchmark performance of a particular ACS technology, but the ACS evaluation system may be used to evaluate performance of different ACS technologies, including different versions of an ACS technology. FIG. 7 depicts at 700 an example flow diagram for evaluating performance of two different ACS technologies. Text pairs may be received at 702, e.g., from a database of an ACS technology or external sources. For example, a pair of texts may include a student response and a concept that are associated with a test item, a student response and a model response, a student response and a text that is not associated with a test item, or two texts that are not associated with a test item.

Data of the ACS technology's entailment determination are received at 704, including data related to the ACS technology's determination on whether one text in each text pair or part of the text entails the other text in the text pair, does not entail the other text, or refutes the other text. Data of human entailment determination are received at 706, including data related to one or more human raters' determination, based on a reason (or category), on whether one text in each text pair or part of the text entails the other text in the text pair, does not entail the other text, or refutes the other text.

A set of engine tests may be built at 708, based on the received text pairs, the received data of ACS entailment determination, and the received data of human entailment determination. An engine test may be in the form of <Test_Id, Text, Hypothesis, Human_Label, ACS_Label, Category>. The agreements/disagreements between the Human_Labels and the ACS_Labels of the set of engine tests may be recorded.

Data of entailment determination of another ACS may be received at 710, including data related to another ACS technology's determination on whether one text in each text pair or part of the text entails the other text in the text pair, does not entail the other text, or refutes the other text. The ACS_Labels of the set of engine tests may be updated at 712 to indicate another ACS technology's entailment determination. The agreements/disagreements between the Human_Labels and the updated ACS_Labels of the set of engine tests may be recorded. The ACS labels of certain engine tests may change upon updating. Or the agreements/disagreements between the Human_Labels and the updated ACS_Labels for certain engine tests may be different from the agreements/disagreements between the Human_Labels and the ACS_Labels of these engine tests before updating. Under these circumstances, these engine tests may be displayed for a human rater to verify at 714. The consistency/performance of the ACS technologies may be evaluated based on the engine test changes.

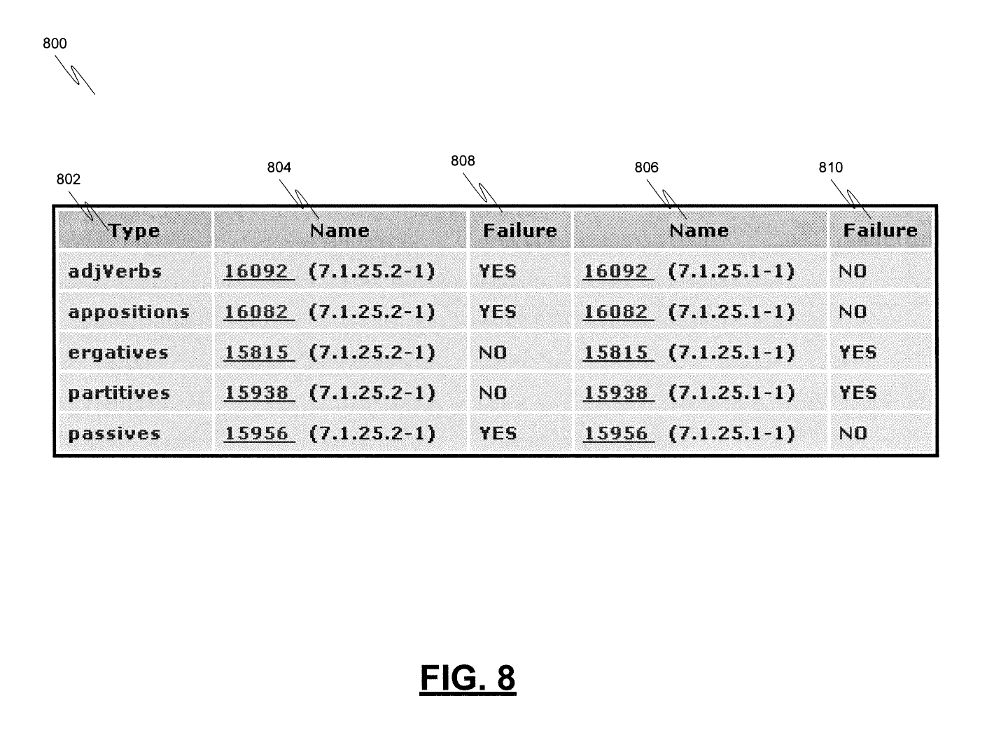

FIG. 8 shows at 800 an example comparative results when two ACS technologies apply to a set of engine tests. Column 802 shows “categories” of certain engine tests where a change occurs, including “adjVerbs,” “appositions,” “ergatives,” “partitives,” and “passives.” Columns 804 and 806 show ID numbers (e.g., 16092) and version numbers (e.g., 7.1.25.1-1) of these engine tests. Changes in these engine tests with application of the two ACS technologies can be seen in the values of the Failure columns (e.g., columns 808 and 810), i.e., {Yes, No}. “Yes” means ACS Label is different from Human_Label, and “No” means ACS_Label is the same as Human_Label. A human rater may click to see these engine tests in details.

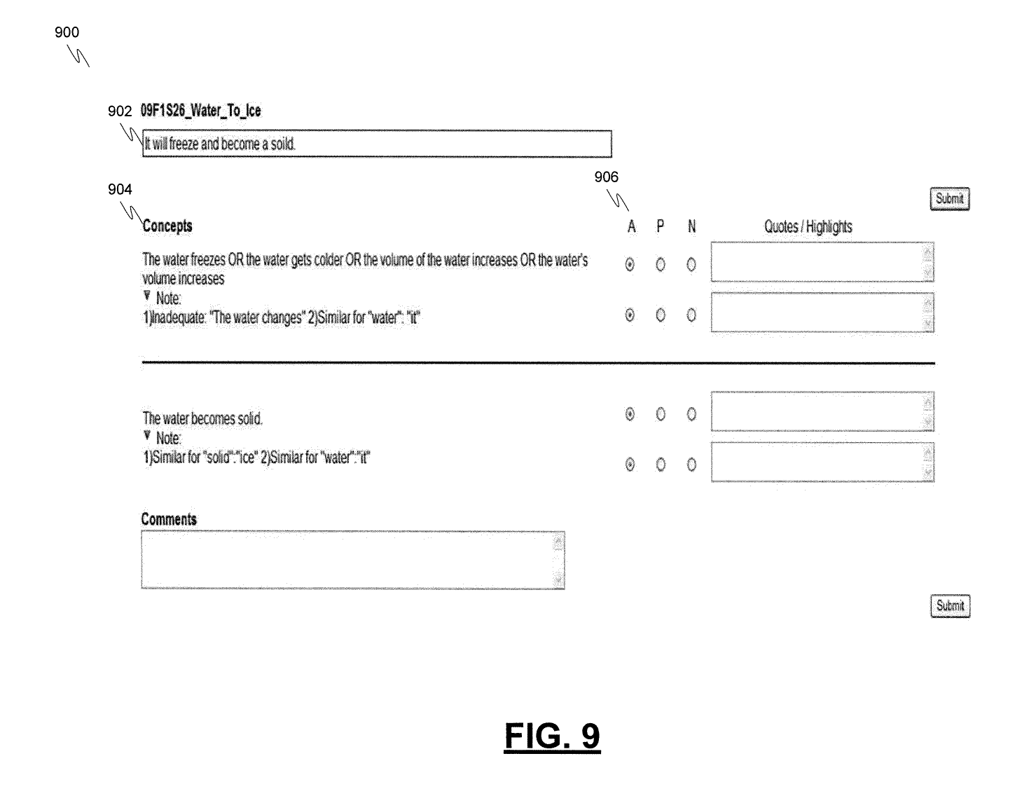

FIG. 9 depicts an example screen shot 900 of an ACS evaluation system. For example, a student response 902 and concepts 904 associated with a test item are provided for annotation, e.g., by one or more human raters or an ACS technology. Initially, labels 906 indicating whether the student response 902 entails any of the concepts 904 are marked “A,” i.e., “Absent.” The labels 906 may be updated, e.g., by one or more human raters or the ACS technology. Categories related to the labels 906 may be provided for selection as an option.

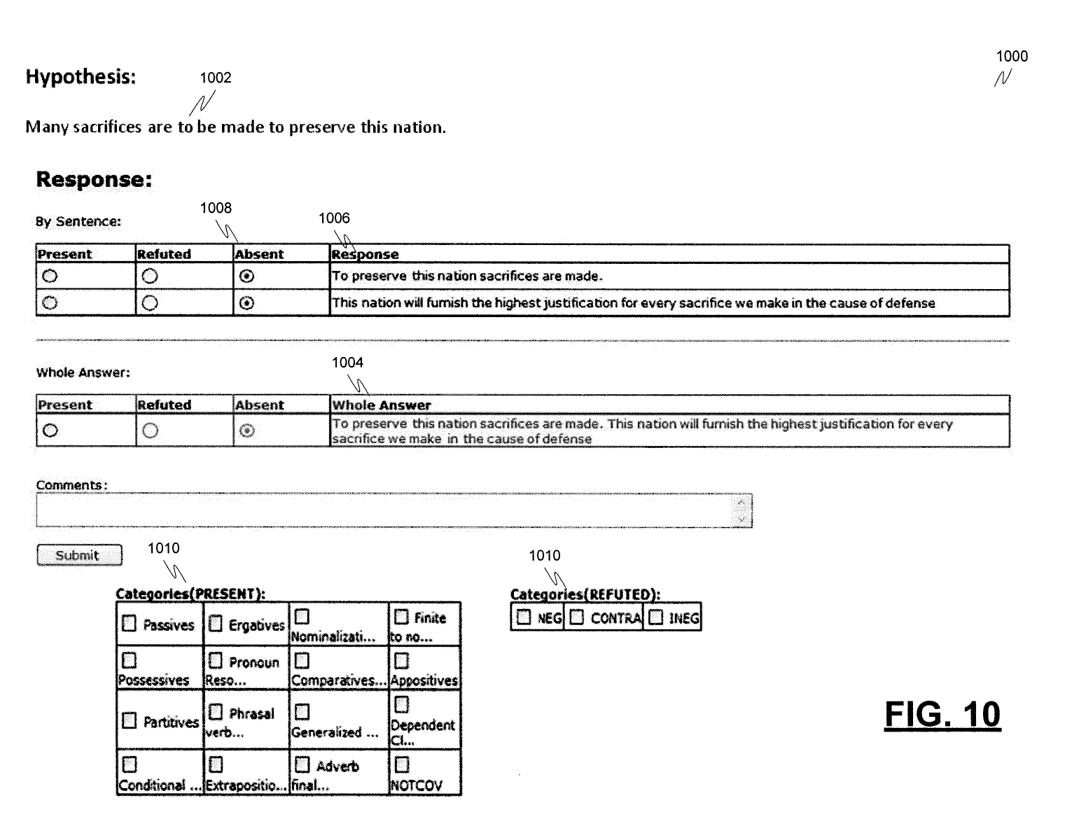

FIG. 10 depicts another example screen shot 1000 of an ACS evaluation system. For example, a text pair including a hypothesis 1002 and an answer 1004, not associated with a test item, are extracted from a data base of an ACS technology or from external sources (e.g. internet sources, test item rubrics, etc.). The hypothesis 1002, the answer 1004, and parts of the answer 1006 are provided for annotation, e.g., by one or more human raters or an ACS technology. Initially, labels 1008 indicating whether the answer 1004 or parts of the answer 1006 entail the hypothesis 1002 are marked “Absent.” The labels 1008 may be updated, e.g., by one or more human raters or the ACS technology. Categories 1010 related to the labels 1008, e.g., “Present” and “Refuted,” may be provided for selection as an option.

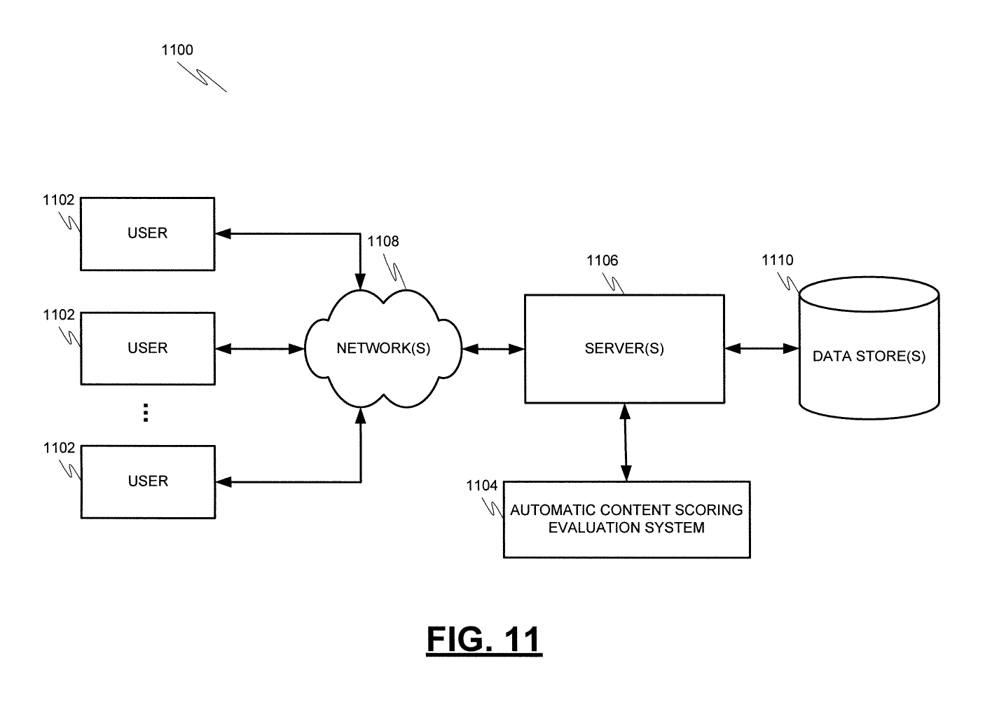

FIG. 11 depicts a computer-implemented environment 1100 wherein users 1102 can interact with an ACS evaluation system 1104 hosted on one or more servers 1106 through a network 1108. The users 1102 can interact with the system 904 through a number of ways, such as over one or more networks 1108. One or more servers 1106 accessible through the network(s) 1108 can host the ACS evaluation system 1104. The one or more servers 1106 are responsive to one or more data stores 1110 for providing input data to the ACS evaluation system 1104.

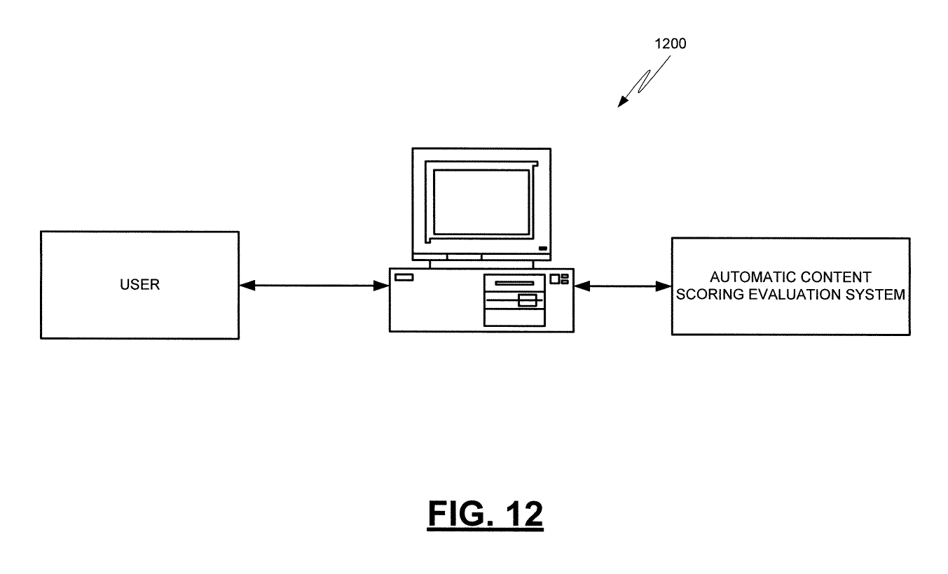

This written description uses examples to disclose the invention, including the best mode, and also to enable a person skilled in the art to make and use the invention. The patentable scope of the invention may include other examples. For example, a computer-implemented system and method can be configured such that an ACS evaluation system can be provided on a stand-alone computer for access by a user, such as shown at 1200 in FIG. 12.

As another example, a computer-implemented system and method may be configured for regression testing i.e. systematic diagnostic and comparative evaluation for the performance of two different ACS technologies, or benchmarking performance evaluation for an ACS technology. As another example, a computer-implemented system and method can be configured to provide a finer-grained view of an ACS technology's performances, increases confidence about the correctness of scores generated from the ACS technology, and provides guidance for product development. As yet another example, a computer-implemented system and method may be configured to further categorize engine tests under each category as follows.

Type 1: Sanity Check Engine Tests. These are entailments that look too trivial not to perform. However, one should emphasize, these may not be as trivial as they look when dealing with noisy data.
(1) <Test_Id1, “The animal is infected”, “The animal is infected”, Present, _, Identical>.

Type 2: Single Phenomenon Single Sentence Engine Tests. These are engine tests where both the “Hypothesis” and the “Text” consist of single sentences and where the entailment is due to a single phenomenon.
(2) <Test_Id2, “The bill should not be passed because psychologists do not have the training of medical doctors to know when drugs should and should not be prescribed, how different drugs work together, what types of side effects occur, and how to deal with these effects when they do occur.”, “Psychologists are not trained”, Present, _, Nom_to_Verb>, where Nom_to_Verb denotes “nominalization to tensed clause.”

Type 3: Single Phenomenon Multi-Sentence Engine Tests. These are engine tests where either the Hypothesis or the Text consists of multi-sentences and where the entailment is due to a single phenomenon.
(3) <Test_Id3, “The fish populations will proball decreas a lot. If they constantly have to breath likd that then it will over stress their body killing them”, “This will decrease the fish populations”, Present, _, Ergative>.

Type 4: Multi-Phenomena Single Sentence Engine Tests. These are engine tests where an entailment is due to more than one phenomenon and both “Text” and “Hypothesis” are single sentences. Such an engine test will appear under more than one Category.
(4) <Test_Id4, “The gasses make the fish fight for air and make the fish needs to breathe more fast to get more oxygen than before.”, “The gas makes the fish need to breath faster to get more oxygen”, Present,_, Category>.

Type 5: Multi-Phenomena Multi-Sentence Engine Tests. These are tests where an entailment is due to more than one phenomenon and either “Text” or “Hypothesis” consists of multi-sentences.
(5) <Test_Id5, “It is supposed to show that presient Johnson knows how to do the job and that he wants to fix the problems for the common worker and American. It also shows how Gladwater believes that draft si a waste and that people who join voluntarily join the military will be better then those who are forced to”, “Gladwater believes people should join the army voluntarily”, Present,_, Category>. At least, the distributive property and the properties of dependent/relative clauses are at play in Test_Id5.

Type 6: Manually-Injected Variations of Engine Tests. As mentioned earlier, the “Text” in some engine tests may be injected manually with some variations for their entailment to fail. These are devised purposely to avoid false positives. An example under the passives Category follows.
(6) <TestId6, “The animal was infected by the doctor”, “The animal infects the doctor”, Absent, _, Passives>, where the original Text is: “The doctor was infected by the animal”.

As another example, a computer-implemented system and method may be configured to build engine tests having a format: <Test_Id, Text, Hypothesis, Human_Label, c-rater_Label, Category, List_of_Modules_Outputs>, where List_of_Modules_Outputs may be optionally displayed and include one or more of the following elements: Text_after_Spelling_Correction, Hypothesis_after_Spelling_Correction, Text_Parser_Output, Hypothesis_Parser_Output, Text_Feature_Extractor_Output, Hypothesis_Feature_Extractor Output, Text_Morphology_Module_Output, Hypothesis_Morphology_Module_Output, and Concept_Detection_Module_Output.

For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of evaluating a first automatic content scoring technology, said method comprising:
receiving a first text and a second text;
receiving a determination by the first automatic content scoring technology on whether at least a portion of the first text entails the second text, does not entail the second text, or refutes the second text;
receiving a determination by a human rater on whether at least a portion of the first text entails the second text, does not entail the second text, or refutes the second text, and a reason for the determination by the human rater;
comparing the determination by the first automatic content scoring technology and the determination by the human rater; and
outputting a first report indicating quality of the determination by the first automatic content scoring technology, wherein the first report shows disagreement between the determination by the first automatic content scoring technology and the determination by the human rater based on the reason.

2. The method of claim 1, wherein the first text is a student response and the second text is a concept; and
wherein the student response and the concept are associated with a test item, the test item requiring a specific set of concepts.

3. The method of claim 1, wherein the first text and the second text are not associated with a test item.

4. The method of claim 1, further comprising:
receiving a reason for the determination by the first automatic content scoring technology, the reason being verified by one or more human raters.

5. The method of claim 1, wherein the reason for the determination by the human rater includes a linguistic phenomenon, an unexpected output of an NLP module of the first ACS technology, mixed-mode representation, and unconventional textual representation.

6. The method of claim 1, further comprising:
adjusting parameters of the first automatic content scoring technology, based on the first report and the reason for the determination by the human rater, to reduce disagreement between the determination by the first automatic content scoring technology and the determination by the human rater.

7. The method of claim 1, further comprising:
repeating the steps of claim 1 until a predetermined number of texts are processed.

8. The method of claim 1, further comprising:
building one or more engine tests based on the first text and the second text, the determination by the first automatic content scoring technology, and the determination by the human rater.

9. The method of claim 8, wherein building one or more engine tests includes:
assigning at least a portion of the first text, the second text, and a label for the reason for the determination of the human rater to an engine test.

10. The method of claim 9, wherein the label for the reason for the determination of the human rater includes one of the following:
“Semantics_Beyond_Lexicon,” “Passives,” “Ergative,” “Partitives,” “Possessives,” “Comparatives and Super-latives,” “Phrasal Verbs,” “Appositives,” “Dependent Clauses other than appositives,” “Interrogatives”, “Extraposition,” “Adverb final and non final,” “Nominalization to Tensed Clause,” “Finite to Non-finite Constructions,” “None of the syntactic categories above,” “Exact Lexical Overlap,” “Direct Synonymy Replacement” (not including compound synonymy), “Compound Synonymy,” “Lexical Inference,” “Compounds_Other,” “tool/module X,” “Explicit Negation,” “Implicit Negation,” and “Contradictory Information (other than negation).”

11. The method of claim 9, wherein building one or more engine tests includes:
generating one or more third texts based on variations of at least a portion of the first text;
wherein the one or more third texts do not entail the second text;
assigning the label for the reason for the determination of the human rater, the second text and the one or more third texts to one or more engine tests.

12. The method of claim 1, further comprising:
receiving a determination by a second automatic content scoring technology on whether at least a portion of the first text entails the second text, does not entail the second text, or refutes the second text;
comparing the determination by the second automatic content scoring technology and the determination by the human rater;
generating a second report indicating quality of the determination by the second automatic content scoring technology;
comparing the first report and the second report; and
outputting a third report indicating difference between the first automatic content scoring technology and the second automatic content scoring technology based on the comparison of the first report and the second report.

13. The method of claim 12, wherein the second automatic content scoring technology is a different version of the first automatic content scoring technology.

14. The method of claim 1, wherein the first text includes atypical data;
wherein atypical data includes noise, unconventional textual representation and mixed-mode representation;
wherein the noise includes incomplete sentences, misspellings, ungrammaticality and random keyboard indefinite stroking of the same letter;
wherein the unconventional textual representation includes symbols, short message service (SMS) abbreviations, foreign and slang words; and
wherein the mixed-mode representation includes visual, textual and mathematical symbolic language.

15. The method of claim 1, wherein the first report includes one or more of the following: kappa statistics, confusion matrices, precision and recall, and a confusion matrix.

16. The method of claim 1, wherein the determination by the human rater is based on independent annotations of two human raters, and a third human rater's adjudication if the two human raters disagree.

17. A computer-implemented system for providing a score for a spontaneous non-native speech response to a prompt, comprising:
one or more data processors;
a computer-readable medium encoded with instructions for commanding the one or more data processors to execute steps including:
receiving a first text and a second text;
receiving a determination by the first automatic content scoring technology on whether at least a portion of the first text entails the second text, does not entail the second text, or refutes the second text;
receiving a determination by a human rater on whether at least a portion of the first text entails the second text, does not entail the second text, or refutes the second text, and a reason for the determination by the human rater;
comparing the determination by the first automatic content scoring technology and the determination by the human rater; and
outputting a first report indicating quality of the determination by the first automatic content scoring technology, wherein the first report shows disagreement between the determination by the first automatic content scoring technology and the determination by the human rater based on the reason.

18. The system of claim 17, wherein the computer-readable medium is encoded with instructions for commanding the one or more data processors to execute further steps including:
building one or more engine tests based on the first text and the second text, the determination by the first automatic content scoring technology, and the determination by the human rater.

19. The system of claim 17, wherein the computer-readable medium is encoded with instructions for commanding the one or more data processors to execute further steps including:
receiving a determination by a second automatic content scoring technology on whether at least a portion of the first text entails the second text, does not entail the second text, or refutes the second text;
comparing the determination by the second automatic content scoring technology and the determination by the human rater;
generating a second report indicating quality of the determination by the second automatic content scoring technology;
comparing the first report and the second report; and
outputting a third report indicating difference between the first automatic content scoring technology and the second automatic content scoring technology based on the comparison of the first report and the second report.

20. A computer-readable medium encoded with instructions for commanding one or more data processors to execute a method for providing a score for a spontaneous non-native speech response to a prompt, the method comprising:
receiving a first text and a second text;
receiving a determination by the first automatic content scoring technology on whether at least a portion of the first text entails the second text, does not entail the second text, or refutes the second text;
receiving a determination by a human rater on whether at least a portion of the first text entails the second text, does not entail the second text, or refutes the second text, and a reason for the determination by the human rater;
comparing the determination by the first automatic content scoring technology and the determination by the human rater; and
outputting a first report indicating quality of the determination by the first automatic content scoring technology, wherein the first report shows disagreement between the determination by the first automatic content scoring technology and the determination by the human rater based on the reason.
